(19) United States
(12) Patent Application Publication
(10) Pub. No.: US 2025/0219152 A1
(43) Pub. Date: Jul. 3, 2025

(54) ALL-SOLID-STATE BATTERY, MANUFACTURING METHOD OF THE SAME, AND CONDUCTIVE COATING CURRENT COLLECTOR

(71) Applicant: TOYOTA JIDOSHA KABUSHIKI KAISHA, Toyota-shi (JP)

(72) Inventor: Ryuto SAKAMOTO, Okazaki-shi (JP)

(73) Assignee: TOYOTA JIDOSHA KABUSHIKI KAISHA, Toyota-shi (JP)

(21) Appl. No.: 18/921,191

(22) Filed: Oct. 21, 2024

(30) Foreign Application Priority Data
Dec. 27, 2023 (JP) 2023-221279

(51) Int. Cl. H01M 10/0585; H01M 4/02; H01M 4/04; H01M 4/139; H01M 4/66; H01M 10/0525

(52) U.S. Cl. CPC H01M 10/0585; H01M 4/0404; H01M 4/0407; H01M 4/043; H01M 4/139; H01M 4/663; H01M 4/667; H01M 4/668; H01M 10/0525; H01M 2004/027; H01M 2004/028

(57) ABSTRACT

A method of manufacturing an all-solid-state battery includes: a step of forming a conductive first coating layer in a first region; a step of forming a second coating layer adjacent to the first coating layer in a second region, the second coating layer being easier to peel off than the first coating layer; a step of forming a first electrode layer continuously over the surfaces of the first and second coating layers: a step of forming a solid electrolyte layer on the surface of the first electrode layer; a step of forming a second electrode layer on the surface of the solid electrolyte layer; a step of hot pressing the obtained current collector-electrode composite; a step of removing the second coating layer with each layer thereon from the first current collector; and a step of laminating a second current collector on the surface of the second electrode layer.

### CROSS-REFERENCE TO RELATED APPLICATION

This application claims priority to Japanese Patent Application No. 2023-221279 filed on Dec. 27, 2023, incorporated herein by reference in its entirety.

### BACKGROUND

### 1. Technical Field

The present application relates to an all-solid-state battery, a manufacturing method of an all-solid-state battery, and a conductive coating current collector.

### 2. Description of Related Art

Japanese Unexamined Patent Application Publication No. 2019-200947 (JP 2019-200947 A) describes an all-solid-state battery and a method for producing the all-solid-state battery.

### SUMMARY

JP 2019-200947 A describes that an all-solid-state battery is manufactured by stacking a positive electrode body, a solid electrolyte layer, and a negative electrode body to obtain a stacked body, and hot pressing the stacked body. However, since a positive electrode active material layer, a negative electrode active material layer, and a solid electrolyte layer are manufactured by coating a slurry, deformation (sagging) occurs due to the slurry flowing after coating, and deviation from an ideal shape occurs. The sagging of each layer results in a decrease in energy density.

The present disclosure provides a manufacturing method of an all-solid-state battery capable of reducing performance degradation due to coating sagging. Moreover, a conductive coating current collector is provided. Moreover, an all-solid-state battery is provided.

The present disclosure encompasses the following embodiments [1] to [3].

[1] A manufacturing method of an all-solid-state battery, the manufacturing method including
forming a conductive first coating layer in a first region that occupies one part of a first surface of a first current collector;
forming a second coating layer adjacent to the first coating layer in a second region on a first surface of the first current collector that occupies an outer peripheral side of the first coating layer, the second coating layer being a coating layer that more easily peels off from the first surface of the first current collector than the first coating layer, forming a first electrode layer that includes a first active material and has a first polarity on
a surface of the first coating layer and the second coating layer of a conductive coating current collector obtained by the forming the first coating layer and the forming the second coating layer, the first electrode layer being continuously formed over the surface of the first coating layer and the surface of the second coating layer,
forming a solid electrolyte layer that includes a solid electrolyte on the surface of the first electrode layer,
forming a second electrode layer that includes a second active material and has a second polarity on a surface of the solid electrolyte layer, the second polarity being an opposite polarity to the first polarity,
hot pressing a current collector-electrode composite obtained through the forming the first coating layer to the forming the second electrode layer,
removing the second coating layer from the first current collector together with a portion of the first electrode layer stacked on the second coating layer, a portion of the solid electrolyte layer stacked on the second coating layer, and a portion of the second electrode layer stacked on the second coating layer, and
stacking a second current collector on a surface of the second electrode layer of the current collector-electrode composite through the hot pressing and the removing the second coating layer.

[2] A conductive coating current collector that has a conductive coating layer, the conductive coating current collector including
a plate shaped, sheet shaped, or foil shaped conductive base material,
a conductive first coating layer provided in a first region that occupies one part of a first surface of the conductive base material, and
a second coating layer disposed adjacent to the first coating layer in a second region of the first surface of the conductive base material that occupies an outer peripheral side of the first coating layer, in which
the second coating layer is a coating layer more easily peeled off from the first surface of the conductive base material than the first coating layer.

[3] An all-solid-state battery including
a first current collector,
a conductive coating layer provided in a first region that occupies one part of a first surface of the first current collector,
a first electrode layer that includes a first active material and has a first polarity, the first electrode layer being provided in contact with the coating layer without directly contacting the first current collector,
a solid electrolyte layer that includes a solid electrolyte,
a second electrode layer that includes a second active material and has a second polarity opposite to the first polarity,
a second current collector electrically connected to the second electrode layer, and
a stacked structure in which the first current collector, the conductive coating layer, the first electrode layer, the solid electrolyte layer, the second electrode layer, and the second current collector are stacked in order in a first direction, in which
a second region not covered by the coating layer is present on an outer peripheral side of the first region of the first surface of the first current collector, and
an end surface of the coating layer, an end surface of the first electrode layer, an end surface of the solid electrolyte layer, and an end surface of the second electrode layer are aligned with one another.

In the manufacturing method of an all-solid-state battery of the present disclosure, a first coating layer is provided on a first region of a first current collector surface (forming a first coating layer), a second coating layer is provided on an outer side of the first coating layer adjacent to the first coating layer (forming a second coating layer), a first electrode layer, a solid electrolyte layer, and a second electrode layer are formed on the first coating layer and the second coating layer (forming a first electrode layer to forming a second electrode layer), and the second coating layer is removed from the first current collector. Accordingly, a peripheral edge portion of each layer where coating sagging easily occurs can be removed along with the second coating layer. Therefore, according to the manufacturing method of an all-solid-state battery of the present disclosure, it is possible to remove a portion where deformation due to coating sagging occurs, and to reduce performance degradation due to coating sagging.

The conductive coating current collector of the present disclosure is in a state where the forming the first coating layer and the forming the second coating layer of the manufacturing method of the all-solid-state battery are completed. Therefore, the conductive coating current collector of the present disclosure can be preferably used for the manufacture of an all-solid-state battery in which performance degradation due to coating sagging is reduced.

In the all-solid-state battery of the present disclosure, since each end surface of the first electrode layer, the solid electrolyte layer, and the second electrode layer is aligned, it is possible to reduce performance degradation caused by deformation due to coating sagging. In addition, since a coating layer is provided on one part of the first surface of the first current collector, and the first electrode layer is provided in contact with the coating layer without being in direct contact with the first current collector, a portion that can be used as a terminal is exposed at an outer peripheral portion of the first current collector. In this way, it is possible to improve the workability of electrically connecting the all-solid-state battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a flow chart illustrating a manufacturing process S10 of an all-solid-state battery according to an embodiment;

FIG. 2A is a cross-sectional view schematically illustrating a first coating step S1;

FIG. 2B is a plan view of a I-I arrow of FIG. 2A;

FIG. 2C is a cross-sectional view schematically illustrating of a first coating step S1;

FIG. 2D is a plan view of a II-II arrow of FIG. 2C;

FIG. 2E is a cross-sectional view schematically illustrating a second coating step S2;

FIG. 2F is a plan view of a III-III arrow of FIG. 2E;

FIG. 2G is a cross-sectional view schematically illustrating a first electrode layer forming step S3;

FIG. 2H is a plan view of a IV-IV arrow of FIG. 2G;

FIG. 2I is a cross-sectional view schematically illustrating a solid electrolyte layer forming step S4;

FIG. 2J is a plan view of a V-V arrow of FIG. 2I;

FIG. 2K is a cross-sectional view schematically illustrating a second electrode layer forming step S5;

FIG. 2L is a plan view of a VI-VI arrow of FIG. 2K;

FIG. 2M is a cross-sectional view schematically illustrating the thermal pressing step S6 and removing step S7;

FIG. 2N is a plan view of a VII-VII arrow of FIG. 2M;

FIG. 2O is a cross-sectional view schematically illustrating the second current collector volume layer step S8; and

FIG. 2P is a plan view of a VIII-VIII arrow in a view of FIG. 2O.

### DETAILED DESCRIPTION OF EMBODIMENTS

Hereinafter, embodiments of the present disclosure will be described with reference to the drawings. However, the present disclosure is not limited to these forms. It should be noted that the drawings do not necessarily reflect exact dimensions. In the drawings, some reference numerals may be omitted. In the present specification, unless otherwise specified, the expression “A to B” for the numerical values A and B shall mean “A or more and B or less”. In such notation, if only the numerical value B is indicated by a unit, such unit shall also apply to the numerical value A. Also, the terms “or” and “or” shall mean a logical sum unless otherwise specified. Also, for the elements E₁ and E₂, the notation “E₁ and/or E₂” means “E₁ or E₂, or a combination thereof”. For the elements E₁, . . . , E_{N} (N is an integer greater than or equal to 3), the notation “E₁, . . . , E_{N-1}, and/or E_{N}” means “E₁, . . . , E_{N-1}, or E_{N}, or a combination thereof”.

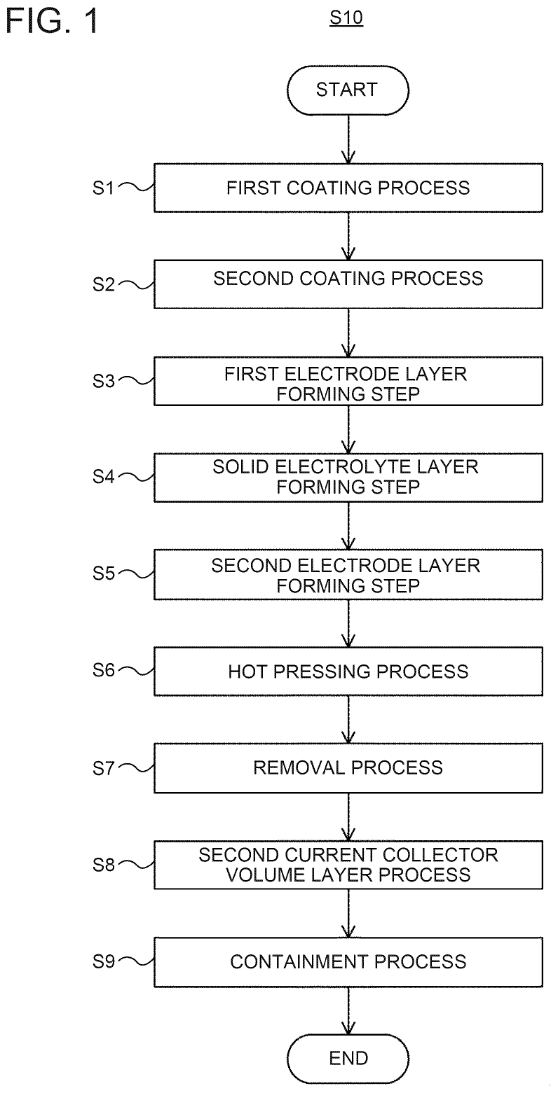

FIG. 1 is a flow chart for explaining a manufacturing process S10 (hereinafter referred to as “manufacturing process S10”) for an all-solid-state battery according to an embodiment. The manufacturing process S10 includes, in this order, a first coating step S1, a second coating step S2, a first electrode layer forming step S3, a solid electrolyte layer forming step S4, a second electrode layer forming step S5, a thermal pressing step S6, a removing step S7, a second current collector volume layer step S8, and a storage step S9. Hereinafter, each step will be described in order.

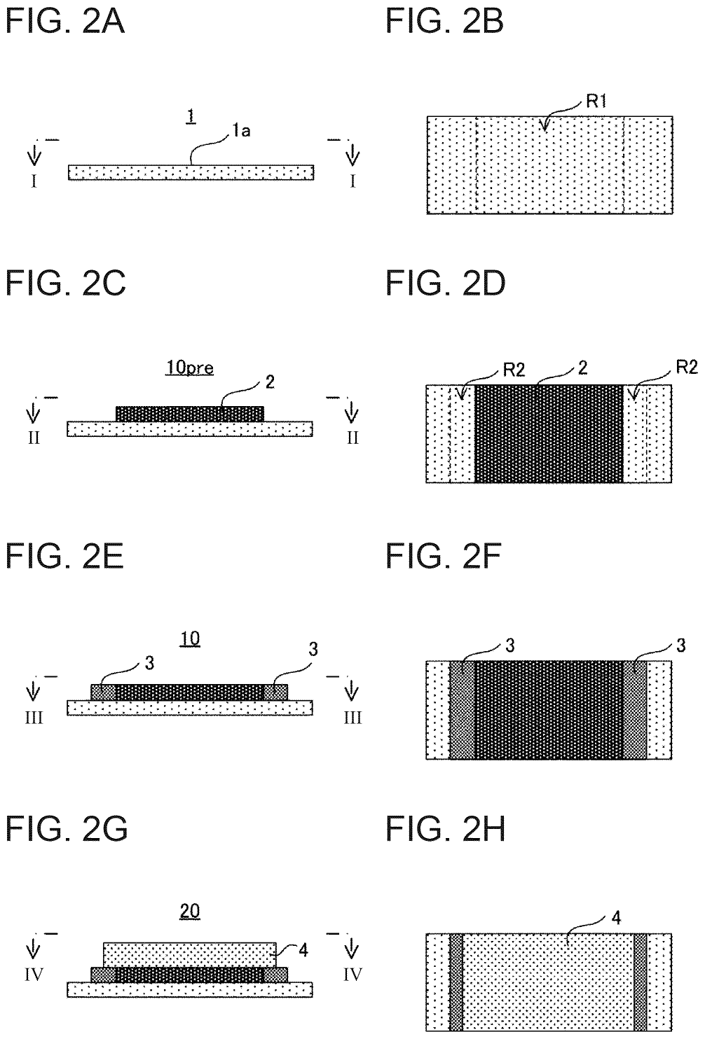

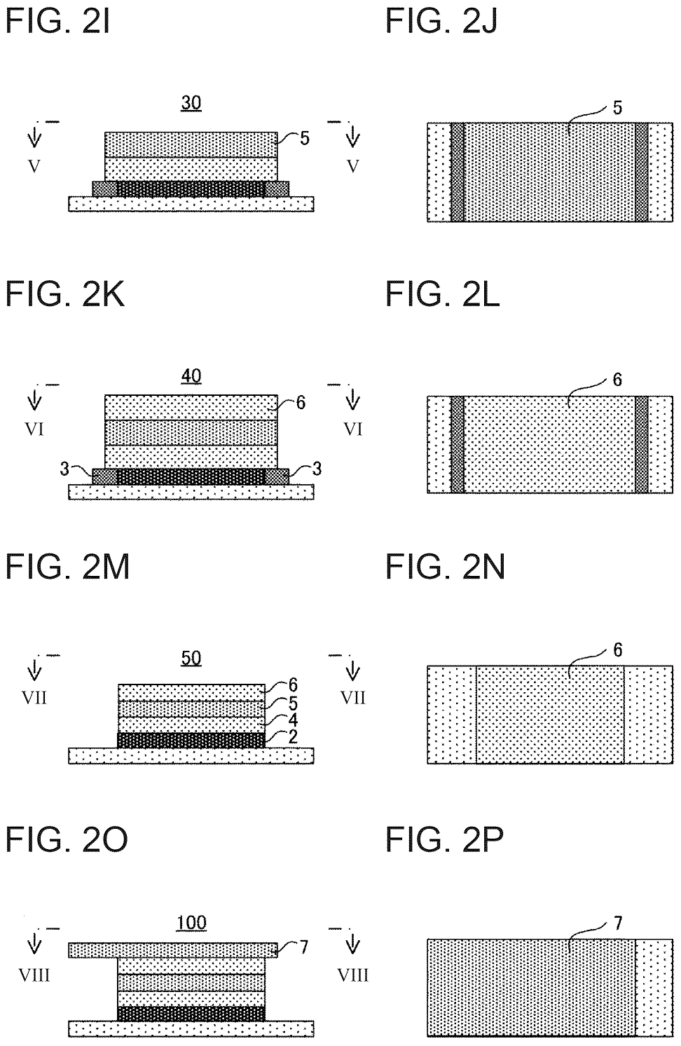

FIGS. 2A to 2P are each a diagram schematically illustrating a manufacturing process S10. FIGS. 2A and 2C are cross-sectional views schematically illustrating the first coating step S1 (hereinafter referred to as “step S1”). FIG. 2B is a plan view of I-I arrow of FIG. 2A, and FIG. 2D is a plan view of II-II arrow of FIG. 2C. The step S1 is a process of forming the conductive first coating layers 2 on the first regions R1 occupying a part of the first surface 1a of the first current collector 1.

As the first current collector 1 (hereinafter, referred to as “current collector 1”), a current collector formed of an appropriate conductive material can be adopted in accordance with whether a first electrode layer to be described later is a positive electrode layer or a negative electrode layer. The current collector 1 includes, for example, a plate-like, sheet-like, or foil-like conductive base material. As the current collector 1, for example, a member made of a metallic material containing one or more elements selected from Cu, Ni, Al, V, Au, Pt, Mg, Fe, Ti, Pb, Co, Cr, Zn, Ge, In, Sn, and Zr can be used. As another example, a member including a conductive or electrically insulating base material (for example, a resin film or the like) and the metal material on which the surface of the base material is deposited or plated may be used as the current collector 1.

As a composition for applying the first coating layer 2 (hereinafter referred to as “coating layer 2”), a composition containing a binder and a conductive filler can be preferably used. In the step S1, the conductive first coating layer 2 can be formed by coating, for example, a slurry containing a binder and a conductive filler. The slurry may further comprise a suitable solvent. One or more binders may be used alone or in combination. From the viewpoint of suppressing the peeling of the first coating layer 2 in the thermal pressing step S6 described later, a thermoplastic having a melting point of 165° C. or higher can be preferably used as the binder. The upper limit of the melting point of the binder resin is not particularly limited, but may be 200° C. or lower in one embodiment. Examples of the thermoplastic resin that may be included in the first coating layer 2 include halogen-containing polymers such as polyvinylidene fluoride (PVDF), polytetrafluoroethylene (PTFE), and polychlorotrifluoroethylene (PCTFE). One or more conductive fillers may be used alone or in combination. As the conductive filler, carbon material fillers such as furnace black, carbon black (CB), Ketjen black (KB), acetylene black (AB), activated carbon, carbon, graphite, vapor-grown carbon fibers (VGCF), carbon nanotubes (CNT), and carbon nanofibers (CNF) can be preferably used. The mean primary particle size of the carbon material fillers can be, for example, from 10 nm to 20 μm. Here, the average primary particle diameter is obtained as an arithmetic average obtained by measuring 30 or more primary particle diameters (average of minor diameters and major diameters) based on image analysis using an electron microscope such as a SEM (scanning electron microscope).

Examples of the conductive filler other than the carbon material filler include metallic particles such as Cu, Ni, Al, V, and Au, Pt, Mg, Fe, Ti, Pb, Co, Cr, Zn, Ge, In, Sn, Zr. The mean particle diameter (D₅₀) of the mineral fillers can be, for example, from 50 nm to 5 μm. In the present specification, the mean particle diameter (D₅₀) means a median diameter corresponding to a median of a volume distribution measured based on a spherical approximation by a laser diffraction/scattering particle size distribution measuring method.

The content of the conductive filler in the first coating layer 2 is preferably 15% by volume or more, as a volume % at 25° C. based on the total amount of the first coating layer 2 (100% by volume), from the viewpoint of increasing the conductivity of the first coating layer 2, and may preferably be 60% by volume or less, from the viewpoint of increasing the adhesion of the first coating layer 2 to the current collector 1. The content of the binder in the first coating layer 2 is preferably 85% by volume or less, as a volume % at 25° C. based on the total amount of the first coating layer 2 (100% by volume), from the viewpoint of enhancing the conductivity of the first coating layer 2, and preferably 40% by volume or more, from the viewpoint of enhancing the adhesion of the first coating layer 2 to the current collector 1.

In one embodiment, the thickness of the first coating layer 2 may be preferably 0.5 μm or more from the viewpoint of enhancing the anchoring effect and preventing peeling, and preferably 4 μm or less from the viewpoint of suppressing peeling caused by the elongation in the in-plane direction.

FIG. 2E is a cross-sectional view schematically illustrating the second coating step S2 (hereinafter referred to as “step S2”), and FIG. 2F is a plan view of III-III arrow in FIG. 2E. The step S2 is a process of forming the second coating layer 3 adjacently to the first coating layer 2 on the second region R2 of the first surface 1a of the first current collector 1, which occupies the outer peripheral side of the first coating layer 2, in the current collector 10 pre including the first coating layer 2 after the step S1. In the step S2, the second coating layer 3 is a coating layer that is more easily peeled off from the first surface 1a of the first current collector 1 than the first coating layer 2.

The second coating layer 3 (hereinafter referred to as “coating layer 3”) preferably includes a binder and a filler. In the step S2, the second coating layer 3 can be formed, for example, by coating a slurry containing a binder and a filler. The slurry may further comprise a suitable solvent. One or more binders may be used alone or in combination. As the binder in the second coating layer 3, (a) a binder having a melting point of 110° C. or less (hereinafter referred to as “binder (a)”), (b) a binder having a Young's modulus at 25° C. of 2.34 GPa or more and a relative dielectric constant at 25° C. of 3.45 or less (hereinafter referred to as “binder (b)”) can be preferably used. In one embodiment, the melting point of the binder (a) may be 110° C. or less, such as from 40 to 110° C. In one embodiment, the melting point of the binder (a) may be a temperature that is 55° C. or higher lower than the hot pressing temperature in the thermal pressing step S6 described later. In one embodiment, the Young's modulus at 25° C. of the binder (b) may be greater than or equal to 2.34 GPa, for example from 2.34 GPa to 4.50 GPa, as the tensile modulus measured at 25° C. according to JISK7161. In one embodiment, the relative dielectric constant at 25° C. of the binder resin may be 3.45 or less, for example 3.10 to 3.45, as the relative dielectric constant measured in 1 MHz at 25° C. according to JISC2138. Examples of the binder (a) include an acrylic pressure-sensitive adhesive, a silicone-based pressure-sensitive adhesive, a rubber-based pressure-sensitive adhesive, polypropylene (PP), and polyethylene (PE). Examples of the binder (b) include polysulfone (PSU), polyphenylsulfone (PPSU), and the like.

In the second coating layer 3, one or more fillers may be used singly or in combination. In one embodiment, the second coating layer 3 preferably comprises a carbon material filler. As the carbon material filler, the carbon material filler described above in relation to the first coating layer 2 can be used. In other embodiments, the second coating layer 3 may include an inorganic filler other than a carbon material. As the inorganic filler, the inorganic filler described above in relation to the first coating layer 2 can be used. A carbon material filler and an inorganic filler may be used in combination.

The content of the filler in the second coating layer 3 is preferably 20% by volume or more from the viewpoint of facilitating the peeling of the second coating layer 3 from the current collector 1, and is preferably 90% by volume or less from the viewpoint of handling properties at the time of peeling of the coating layer, as a volume % at 25° C. based on the total amount of the second coating layer 3 (100% by volume). In one embodiment, from the viewpoint of facilitating the suppression of the adhesion of the second coating layer 3 to the roll in the thermal pressing step S6 described later, the second coating layer 3 may be formed such that the content of the filler in the second coating layer 3 is 40 vol % or more and the end portion of the second coating layer 3 is aligned with the end portion of the current collector, as a volume % at 25° C. based on the total amount of the second coating layer 3 (100 vol %).

In one embodiment, from the viewpoint of facilitating lamination of each layer constituting the battery on the first coating layer 2 and the second coating layer 3, the thickness of the second coating layer 3 may be the same as the thickness of the first coating layer 2. From the viewpoint of securing the strength of the second coating layer 3 and facilitating the removal of the second coating layer 3 together with the layer thereon in the removing step S7 described later, the thickness of the second coating layer 3 may be, for example, from 0.5 μm to 5.0 μm.

The second coating layer 3 is removed from the top surface of the current collector 1 in a removing step S7 described later. The phenomena in which the bonding condition between the second coating layer 3 and the current collector 1 is lost may occur in the thermal pressing step S6, may occur in the second electrode layer forming step S5 or the solid electrolyte layer forming step S4, or may occur in the first electrode layer forming step S3.

The conductive coating current collector 10 according to one embodiment is obtained through the steps S1 and S2. The conductive coating current collector 10 includes a conductive base material 1, a conductive first coating layer 2, and a second coating layer 3. The conductive base material 1 is in the form of a plate, a sheet, or a foil. The first coating layers 2 are provided in a first region R1 that occupies a part of the first surface 1a of the conductive base material 1. The second coating layer 3 is provided adjacently to the first coating layer 2 in the second region R2 of the first surface 1a of the conductive base material 1, which occupies the outer periphery of the first coating layer 2. In the conductive coating current collector 10, the second coating layer 3 is a coat layer that is more easily peeled off than the first coating layer 2. In one embodiment, the second coating layer 3 may be a coating layer that is more easily peeled off from the current collector 1 than the first coating layer 2 when subjected to a shear stress or a stress crossing the first surface 1a of the current collector 1. In another embodiment, the second coating layer 3 may be a coating layer that is easier to peel off from the current collector 1 than the first coating layer 2 when subjected to shear stress or stress in a direction crossing the first surface 1a of the current collector 1.

FIG. 2G is a cross-sectional view schematically illustrating a first electrode layer forming step S3 (hereinafter referred to as “step S3”), and FIG. 2H is a plan view of a IV-IV arrow in FIG. 2G. Step S3 is a step of forming a first electrode layer 4 including a first active material and having a first polarity on the surfaces of the first coating layer 2 and the second coating layer 3 of the conductive coating current collector 10 including the first coating layer 2 and the second coating layer 3. In the step S3, the first electrode layer 4 is formed continuously over the surface of the first coating layer 2 and the surface of the second coating layer 3. In the present embodiment, the first electrode layer 4 is a negative electrode layer including a negative electrode active material (hereinafter referred to as “negative electrode layer 4”).

The negative electrode layer 4 includes a negative electrode active material, a conductive auxiliary agent, and a binder, and may optionally further include a solid electrolyte described later. For example, when a lithium-ion secondary battery is manufactured as an all-solid-state battery, examples of the negative electrode active material include carbon materials such as graphite, artificial graphite, highly oriented graphite, mesocarbon microbeads, hard carbon, and soft carbon, Li₄Ti₅O₁₂, metallic compounds, elements that can be alloyed with lithium or compounds of the elements, boron-added carbon, and the like. Examples of elements that can be alloyed with lithium include silicon and tin.

The binder serves to tether the active material or the conductive aid to the surface of the conductive coating current collector 10 and maintain the conductive network in the electrode. One or more binders may be used alone or in combination. Examples of the binder include polyvinylidene fluoride (PVDF), polytetrafluoroethylene (PTFE), a fluorine-containing resin such as a fluorine-containing rubber, polypropylene (PP), a thermoplastic resin such as polyethylene (PE), polyimide (PI), an imide-based resin such as polyamideimide (PAI), an alkoxysilyl group-containing resin, an acrylic resin containing monomer units such as acrylic acid and methacrylic acid, styrene-butadiene rubber (SBR), carboxymethylcellulose (CMC), sodium alginate, alginate such as ammonium alginate, a water-soluble cellulose ester crosslinked product, and a starch-acrylic acid graft polymer.

Examples of the conductive aid include acetylene black, carbon black, graphite, and the like. For example, viscosity-adjusting solvents such as N-methyl-2-pyrrolidone (NMP) may be used for the negative electrode layers 4.

The negative electrode layer 4 can be formed, for example, by the following procedure. A slurry-like negative electrode mixture is obtained by mixing and kneading a negative electrode active material, a conductive auxiliary agent, a binder, and optionally a solid electrolyte in a solvent. Thereafter, the negative electrode mixture is applied to the surfaces of the first coating layer 2 and the second coating layer 3 of the conductive coating current collector 10 and dried.

FIG. 2I is a cross-sectional view schematically illustrating a solid electrolyte layer forming step S4 (hereinafter referred to as “step S4”), and FIG. 2J is a plan view of a V-V arrow in FIG. 2I. The step S4 is a step of forming a solid electrolyte layer 5 including a solid electrolyte on the first electrode layer (negative electrode layer) 4. One or more solid electrolytes may be used alone or in combination. The solid electrolyte layer 5 includes a negative electrode active material included in the negative electrode layer 4 and a solid electrolyte having the conductivity of ions occluded and released by the positive electrode active material included in the positive electrode layer 6 described later. Examples of solid-state electrolytes having the transmission of lithium ions include oxide solid-state electrolyte such as Li₃PO₄; and sulfide soli-state electrolyte such as Li₂S—P₂S₅, Li₂S—SiS₂, Li₁—Li₂S—SiS₂, Li₁—Si₂S—P₂S₅, Li₁—Li₂S—P₂O₅, Li₁—Li₃PO₄—P₂S₅.

The solid electrolyte layer 5 can be prepared by adding a solid electrolyte and, optionally, a binder to a solvent and kneading the mixture to obtain a slurry electrolyte mixture, and then applying and drying the electrolyte composition. As the binder in the solid electrolyte layer 5, the binder described above in connection with the first electrode layer (negative electrode layer) 4 can be used. The solid electrolyte layer 5 may be formed, for example, by coating an electrolyte mixture directly on the surface of the first electrode layer (negative electrode layer) 4. The solid electrolyte layer 5 may be formed by, for example, the following procedure. An electrolyte mixture is applied to the surface of a substrate such as a metallic foil (e.g., Al foil) to form the solid electrolyte layers 5 on the surface of the substrate. The solid electrolyte layer 5 formed on the surface of the substrate is superposed on the surface of the first electrode layer 4 of the composite body 20 on which the first electrode layer 4 is formed on the conductive coating current collector 10. The solid electrolyte layer 5 is transferred from the substrate surface to the surface of the first electrode layer 4 by press working such as roll pressing.

FIG. 2K is a cross-sectional view schematically illustrating a second electrode-layer forming step S5 (hereinafter referred to as “step S5”), and FIG. 2L is a plan view of a VI-VI arrow in FIG. 2K. The step S5 is a step of forming a second electrode layer 6 including a second active material and having a second polarity on the surface of the solid electrolyte layer 5. In step S5, the second polarity (+/−) is the opposite polarity to the first polarity (−/+). In the present embodiment, the second electrode layer 6 is a positive electrode layer including a positive electrode active material (hereinafter referred to as “positive electrode layer 6”). The positive electrode layer 6 includes a positive electrode active material, a conductive auxiliary agent, and a binder. For example, when the all-solid-state battery manufactured in the manufacturing process S10 is a lithium-ion secondary battery, examples of the positive electrode active material include a complex oxide, metallic lithium, and sulphur. Compositions of the composite oxide include, for example, at least one of iron, manganese, titanium, nickel, cobalt, and aluminum, and lithium. Examples of the complex oxide include olivine-type lithium iron phosphate (LiFePO₄), LiCoO₂, LiNiMnCoO₂, and the like. As the conductive auxiliary agent and the binder in the positive electrode layer 6, the same ones as those used in the negative electrode layer 4 can be used. The positive electrode layer 6 may further include a solid electrolyte. As the solid electrolyte in the positive electrode layer 6, the solid electrolyte described above in relation to the solid electrolyte layer 5 can be used.

The positive electrode layer 6 can be prepared by mixing and kneading a positive electrode active material, a conductive auxiliary agent, a binder, and optionally a solid electrolyte in a solvent to obtain a slurry-like positive electrode mixture, and then applying and drying the positive electrode mixture. The positive electrode layer 6 may be formed, for example, by coating a positive electrode mixture directly on the surface of the solid electrolyte layer 5. The positive electrode layer 6 may be formed, for example, by the following procedure. A positive electrode mixture is coated on the surface of a base material such as a metallic foil (e.g., Al foil) to form the positive electrode layers 6 on the surface of the base material. The positive electrode layer 6 formed on the surface of the substrate is superposed on the surface of the solid electrolyte layer 5 of the composite body 30 in which the negative electrode layer 4 and the solid electrolyte layer 5 are formed on the conductive coating current collector 10. The positive electrode layer 6 is transferred from the substrate surface to the surface of the solid electrolyte layer 5 by press working such as roll pressing. Exemplary solvents for forming each layer include N-methyl-2-pyrrolidone, methanol, methyl isobutyl ketone, water, and the like. In an embodiment, the second electrode layer 6 may be formed across the boundary between the first coating layer 2 and the second coating layer 3 in a plan view. In one embodiment, the boundary between the first coating layer 2 and the second coating layer 3 may be formed on the current collector 1 at a position where the first electrode layer 4, the solid electrolyte layer 5, and the second electrode layer 6 are not cut together (for example, linearly).

FIG. 2M is a cross-sectional view schematically illustrating the thermal pressing step S6 (hereinafter referred to as “step S6”) and the removing step S7 (hereinafter referred to as “step S7”), and FIG. 2N is a plan view of VII-VII arrow in FIG. 2M. The step S6 is a step of hot-pressing the current collector-electrode composite 40 obtained by passing through step S5 from the step S1. Through the step S6, the current collector-electrode composite is densified. The hot pressing can be performed, for example, by roll pressing or the like. The temperature of the hot press may be, for example, a temperature that does not exceed the melting point of the binder contained in the first coating layer 2 by 10° C. or more, or a temperature that does not exceed the melting point of the binder contained in the first coating layer 2. In one embodiment, the temperature of the hot press can be from 130° C. to 200° C. The pressure of the hot press can be, for example, from the linear pressure 3 t/cm to 10 t/cm, for example, when the hot press is performed by a roll press.

The step S7 is a process of removing the second coating layer 2 from the current collector 1 together with a portion laminated on the second coating layer 3 of the first electrode layer (negative electrode layer) 4, a portion laminated on the second coating layer 3 of the solid electrolyte layer 5, and a portion laminated on the second coating layer 3 of the second electrode layer (positive electrode layer) 6. In one embodiment, the second coating layer 3 loses its bonding to the first current collector 1 by being subjected to thermal and stresses of the thermal press in the step S6. In another embodiment, the second coating layer 3 loses its bonding condition with the first current collector 1 by being subjected to press stress when the solid electrolyte layer 5 coated on a substrate such as a Al foil is bonded to the first electrode layer (negative electrode layer) 4 in the step S4. In another embodiment, the second coating layer 3 loses its bonding condition with the first current collector 1 by being subjected to press stress when the second electrode layer (positive electrode layer) 6 coated on a substrate such as an Al foil is bonded to the solid electrolyte layer 5 in the step S5. In either embodiment, the bonding between the second coating layer 3 and the first current collector 1 is lost by the end of the step S6. Therefore, the process of removing the second coating layer 3 from the current collector 1 in the step S7 can be easily performed. Through the step S7, the peripheral edge portion where the coating sagging of the first electrode layer (negative electrode layer) 4, the solid electrolyte layer 5, and the second electrode layer (positive electrode layer) 6 has been applied can be removed together with the second coating layer 3. In the current collector-electrode composite 50 that has undergone the steps S6 and S7, the end faces of the first coating layer 2, the first electrode layer (negative electrode layer) 4, the solid electrolyte layer 5, and the second electrode layer (positive electrode layer) 6 are aligned in the portion from which the second coating layer 3 has been removed, and can be obtained without cutting the current collector-electrode composite.

FIG. 2O is a cross-sectional view schematically illustrating the second current collector volume layer step S8 (hereinafter sometimes referred to as “step S8”), and FIG. 2P is a plan view of VIII-VIII arrow in FIG. 2O. The step S8 is a process of laminating the second current collector (positive electrode current collector) 7 on the second electrode layer (positive electrode layer) 6 of the current collector-electrode composite 50 that has undergone the step S6 and step S7. As the second current collector 7, for example, a current collector such as a plate-like, sheet-like, or foil-like, or porous-like, which is formed of the above-described conductive material in connection with the first current collector, can be used.

The storage step S9 (hereinafter, sometimes referred to as “step S9”) is a process in which the all-solid-state battery 100 obtained by passing through step S8 from the step S1 are stored in an exterior material (not shown) and sealed. As the exterior material, an exterior material that can be used for an all-solid-state battery can be used. Examples of the material that can constitute such an exterior material include metal materials such as aluminum and stainless steel, and resin materials such as polyphenylene sulfide resin and polyimide resin. Further, the shape of the exterior material is not particularly limited, and may be, for example, a circular shape (cylindrical shape, coin shape, button shape), a hexahedral shape (rectangular shape, cubic shape), a bag body shape, a shape obtained by processing and deforming them, or the like. After the step S8, the all-solid-state battery 100 may be partially cut as needed prior to the all-solid-state battery 100 being housed in the exterior material.

The all-solid-state battery 100 has a stacked structure in which a first current collector 1, a coating layer 2, a first electrode layer (negative electrode layer) 4, a solid electrolyte layer 5 including a solid electrolyte, a second electrode layer (negative electrode layer) 6, and a second current collector 7 electrically connected to the second electrode layer 6 are laminated in the above-described order. The coating layer 2 is a conductive coating layer provided in the first region R1 occupying a part of the first surface 1a of the first current collector 1. The first electrode layer (negative electrode layer) 4 is provided in contact with the coating layer 2 without being in direct contact with the first current collector 1. The first electrode layer (negative electrode layer) 4 includes a first active material (negative electrode active material) and has a first polarity (−). The second electrode layer (negative electrode layer) 6 includes a second active material (positive electrode active material) and has a polarity (+) opposite to the first polarity (−). In the all-solid-state battery 100, the end face of the coating layer 2, the end face of the first electrode layer 4, the end face of the solid electrolyte layer 5, and the end face of the second electrode layer 6 are aligned with each other. If the coating sagging remains, such a configuration cannot be obtained. Further, on the first surface 1a of the first current collector, on the outer periphery of the first region R1, there is a second region R2 in which the first current collector is exposed, which is not covered by the coating layer 2. The exposed portion of the first current collector can be preferably utilized as a terminal.

In the above explanation of the present disclosure, the manufacturing process S10 of an all-solid-state battery in which the first electrode layer 4 is a negative electrode layer containing a negative electrode active material and the second electrode layer 6 is a positive electrode layer containing a positive electrode active material, the conductive coating current collector 10, and the all-solid-state battery 100 are mainly exemplified, but the present disclosure is not limited to these forms. For example, the first electrode layer 4 may be a positive electrode layer containing a positive electrode active material, and the second electrode layer 6 may be a negative electrode layer containing a negative electrode active material, a conductive coating current collector, and an all-solid-state battery.

In the above explanation of the present disclosure, a manufacturing process S10 in which an all-solid-state battery that is a lithium-ion secondary battery is manufactured and an all-solid-state battery 100 that is a lithium-ion secondary battery are mainly exemplified, but the present disclosure is not limited to these forms. For example, an active material that occludes and releases ions other than lithium ions (e.g., Na⁺, K⁺, Mg²⁺, Ca²⁺, Al³⁺, Zn²⁺) as a positive electrode active material and a negative electrode active material can be used, and a solid electrolyte that has conductivity of ions that the active material occludes and releases can be used as a solid electrolyte. Accordingly, an all-solid-state battery other than the lithium-ion secondary battery can be used, and a method of manufacturing an all-solid-state battery in a form of manufacturing such an all-solid-state battery can be used.

Hereinafter, the present disclosure will be described in more detail with reference to Examples. However, the present disclosure is not limited to these examples.

### Example 1

An all-solid-state battery was manufactured by the following procedure.

### 1. Preparation of Negative Electrode Current Collector Foil Having Carbon Coating Layer

A negative electrode current collector foil (double-sided CC foil) having carbon coating layers on both surfaces was prepared by the following steps.

The mixture of acetylene black and polyvinylidene fluoride (PVDF) as the conductive material was weighed so that the ratio was 20:80. These were mixed with N-methylpyrrolidone (NMP) to prepare a composition (first CC composition) for the central carbon coating layer (central CC layer; first CC layer). In addition, both were weighed so that the mixture weight ratio of acetylene black of the conductive material and an acrylic binder having a melting point of 110° C. was 20:80. These were mixed with N-methylpyrrolidone (NMP) to prepare a composition for the end CC layer (second CC layer) (second CC composition). A central CC layer (first CC layer) was formed on both surfaces of Al foil in the width 120 mm by center-coating the first CC composition in the width 62 mm. Next, end CC layers (second CC layers) were formed on both sides of the respective central CC layers by applying the second CC composition in the width of 5 mm.

### 2. Formation of the Negative Electrode Layer

To a polypropylene-made container were added PVDF, negative electrode active material (lithiumtitaniumoxide (LTO)) grains, and sulfide solid electrolyte (Li₂S—P₂S₅glass-ceramics). The negative electrode mixture was prepared by stirring them with an ultrasonic dispersing apparatus for 30 minutes. A double-sided CC foil-negative electrode layer laminate was prepared by coating CC layer surface (both surfaces) of the double-sided CC foil prepared in Step 1 with a negative electrode mixture material in a widthwise 70 mm to form a negative electrode layer.

### 3. Formation of a Solid Electrolyte Layer

A solid electrolyte mixture was prepared by adding heptane, butadiene rubber (BR), and the same sulfide solid electrolyte as in step 2 to a polypropylene container and stirring the mixture in an ultrasonic dispersing device for 15 minutes. A solid electrolyte (SE) layer was formed on the surface of Al foil by coating a solid electrolyte mixture in a widthwise 70 mm on the surface of Al foil, thereby producing an Al foil-SE layer-laminated bodies. A plurality of Al foil-SE layer-laminated bodies was prepared.

### 4. Formation of the Positive Electrode Layer

Lithium niobate was coated on positive electrode active material particles (Li_{1.15}Ni_{1/3}Co_{1/3}Mn_{1/3}O₂ main phase particles) in an air atmosphere using a rolling flow type coating device (manufactured by Powleck). Next, firing was performed in an atmosphere to obtain positive electrode active material particles having a coating layer of lithium niobate. A positive electrode mixture was prepared by adding PVDF, the positive electrode active material particles, the sulfide solid electrolyte used in Step 2, and vapor-grown carbon fiber (VGCF; manufactured by Showa Denko Co., Ltd.) to a polypropylene-made container, and stirring the mixture with an ultrasonic dispersing device for 20 minutes. A Al foil-positive electrode layer laminate was prepared by forming a positive electrode layer by coating a positive electrode mixture in a widthwise 65 mm on the front face of a Al foil. A plurality of Al foil-positive electrode layer laminates was prepared.

### 5. Preparation of Negative Electrode Current Collector-Electrode Composite: Transfer Press Process

The double-sided CC foil-negative electrode layer laminate prepared in step 2, Al foil-SE layer laminate prepared in step 3, and Al foil-positive electrode layer laminate prepared in step 4 were cut in the length 80 mm. Al foil-SE layer laminate was disposed on both surfaces of the double-sided CC foil-negative electrode layer laminate so that the center positions of the coated portions were matched. This laminate was roll-pressed 0.4 t/cm a linear pressure to transfer the solid electrolyte layer, thereby obtaining a SE layer-negative electrode layer-double-sided CC foil-negative electrode layer-SE layer laminate. Further, a Al foil-positive electrode layer laminate was placed on both surfaces of the laminate, and the laminate was rolled and pressed 0.4 t/cm linear pressure to transfer the positive electrode layer. As a result, a negative current collector-electrode composite was obtained in which a positive electrode layer-SE layer-a negative electrode layer-a double-sided CC foil-a negative electrode layer-SE layer-a positive electrode layer were laminated in this order.

### 6. Hot Pressing Process

The negative electrode current collector-electrode composite obtained in step 5 was densified by roll-pressing 5t/cm linear pressure at 165° C. for 10 minutes. At that time, peeling of the end CC layers (second CC layers) was confirmed. Thereafter, the negative electrode current collector-electrode composite was cut so that the dimensions of the positive electrode layers were in the width 60 mm by the length 60 mm.

### 7. Preparation and Bonding of Positive Electrode Current Collector Foil

The conductive material acetylene black and PVDF were weighed to a mixing weight-ratio of 20:80, and NMP was further added to prepare a carbon coating (CC) composition (third CC composition). An Al foil (positive electrode current collector foil) having a CC layer (third CC layer) on one side thereof was obtained by coating the third CC composition with a thickness of 2 μm on one side of the Al foil and drying at 100° C. for 1 hour. The positive electrode current collector foil was cut so that the dimensions of CC layers were in the vertical 57 mm and the lateral 57 mm, and was attached to both surfaces of the current collector-electrode composite obtained in step 6. using a styrene-butadiene rubber (SBR) binder. Thus, a battery having a stacked structure of a Al foil-a third CC layer-a positive electrode layer-SE layer-a negative electrode layer-a double-sided CC foil (a first CC layer-Al foil-a first CC layer)-a negative electrode layer-SE layer-a positive electrode layer-a third CC layer-Al foil was produced. After the terminals were bonded to the positive electrode current collector foil and the negative electrode current collector foil, respectively, the battery was vacuum-sealed in a laminate film (exterior material).

### Examples 2 and 3

In Procedure 1, batteries were prepared according to Example 1 and Procedure except that the respective compositions of the first and second CC compositions in making the double-sided CC foil were modified as described in Table 1. In both of Examples 2 and 3, peeling of the end CC layers (second CC layers) was confirmed in the transfer pressing step (Step 5).

### Comparative Examples 1 to 5

In Procedure 1, batteries were prepared according to Example 1 and Procedure except that the respective compositions of the first and second CC compositions in making the double-sided CC foil were modified as described in Table 1. However, in Comparative Examples 1, 2, 4, and 5, since the peeling of the end CC layer (second CC layer) was not confirmed, when the terminal was bonded to the negative electrode current collector foil in Step 7, the terminal was welded to the outer side of the end CC layer (second CC layer). In Comparative Example 3, peeling of the end CC layers was confirmed in the hot pressing step (Step 6).

### Charge-Discharge Test

Each of the batteries manufactured in Examples 1 to 3 and Comparative Examples 1 to 5 was subjected to a charge-discharge test according to the following procedure, and the internal resistance was measured. The batteries to be evaluated were charged at a constant current constant voltage at a charging voltage 2.95V and a charging rate (C-rate) 0.3C, and then discharged to a termination voltage 1.5V. Then, after being charged to 2.17V, constant current discharge was performed at the discharge rate 5C, and the internal resistance was calculated from the voltage change AV.

### Evaluation Results

In Example 1, the end CC layer (second CC layer) was able to be peeled in the hot pressing step (Step 6), whereas in Example 2, the transfer pressing step (Step 5) peeling of the end CC layer was confirmed. In Comparative Examples 1, 2, 4, and 5, the end CC layers could not be peeled off in any of the steps. The fact that the cells of Comparative Example 3 showed high internal-resistance is considered to be attributable to the low electronic conductivity of CC layers in the central portion. In Example 1, the binder in the end CC layer was dissolved in the hot pressing step (Step 6), and due to the presence of carbon in the end CC layer, the end CC layer became slippery, it is considered that peeled off. In Examples 2 and 3, since the binders in the end CC layers are hard, it is considered that in the transfer pressing step (Step 7), a difference in elongation occurred due to the stresses of the press, and peeling of the end CC layers occurred. Even if a binder having a lower melting point was used for the end CC layer, the end CC layer did not peel off when the conductive material (carbon) was not contained (Comparative Examples 1 and 2). This is considered to be due to the fact that no slippage occurred between the binder and the aluminum foil. Even if a thermosetting resin having a lower dielectric constant was used as the binder of the end CC layer, the end CC layer could not be peeled off when only the binder was used (Comparative Examples 1 and 2). This is considered to be due to the high adhesive strength. The end CC layers could not be peeled off when polyamideimide (PAI) or PVDF was used as the binder for the end CC layers (Comparative Examples 4 and 5). These binders are considered to be caused by their high dielectric constant and high adhesive strength.

TABLE 1

| | Central CC zone | | | | End CC layers | | | | | | | | |
|---|---|---|---|---|---|---|---|---|---|---|---|---|---|
| | Binder | | | | | | | | | | | | |
| | properties | | | | Binder properties | | | | | | Delamination | | Internal |
| | | Melting | Composition | | | Melting | Young's | | Composition | | of CC layers | | resistance/ |
| | | point | [vol %] | | | point | modulus | Relative | [Vol %] | | Central | | to Example |
| Table 1 | Resin | [° C.] | Binder | Carbon | Resin | [° C.] | [GPa] | permittivity | Binder | Carbon | part | End | 1 ratio |
| Example 1 | PVDF | 165 | 85 | 15 | Acrylic | 110 | — | — | 80 | 20 | None | Possible | Standard |
| Example 2 | PVDF | 165 | 85 | 15 | PSU | — | 2.34 | 3.45 | 80 | 20 | None | Possible | 1 |
| Example 3 | PVDF | 165 | 85 | 15 | PPSU | — | 2.50 | 3.10 | 80 | 20 | None | Possible | 1 |
| Comparative | PVDF | 165 | 80 | 20 | Acrylic | 110 | — | — | 100 | 0 | None | Not | 1 |
| Example 1 | | | | | | | | | | | | possible | |
| Comparative | PVDF | 165 | 80 | 20 | PPSU | — | 2.50 | 3.10 | 100 | 0 | None | Not | 1 |
| Example 2 | | | | | | | | | | | | possible | |
| Comparative | PVDF | 165 | 90 | 10 | Acrylic | 110 | — | — | 80 | 20 | None | Possible | 3 |
| Example 3 | | | | | | | | | | | | | |
| Comparative | PVDF | 165 | 80 | 20 | PVDF | 165 | 2.50 | 6.40 | 20 | 80 | None | Not | 1 |
| Example 4 | | | | | | | | | | | | possible | |
| Comparative | PVDF | 165 | 80 | 20 | PAI | — | 4.50 | 3.80 | 80 | 20 | None | Not | 1 |
| Example 5 | | | | | | | | | | | | possible | |

What is claimed is:

1. A manufacturing method of an all-solid-state battery, the manufacturing method comprising:
forming a conductive first coating layer in a first region that occupies one part of a first surface of a first current collector;
forming a second coating layer adjacent to the first coating layer in a second region on a first surface of the first current collector that occupies an outer peripheral side of the first coating layer, the second coating layer being a coating layer that more easily peels off from the first surface of the first current collector than the first coating layer;
forming a first electrode layer that includes a first active material and has a first polarity on a surface of the first coating layer and the second coating layer of a conductive coating current collector obtained by the forming the first coating layer and the forming the second coating layer, the first electrode layer being continuously formed over the surface of the first coating layer and the surface of the second coating layer;
forming a solid electrolyte layer that includes a solid electrolyte on the surface of the first electrode layer;
forming a second electrode layer that includes a second active material and has a second polarity on a surface of the solid electrolyte layer, the second polarity being an opposite polarity to the first polarity;
hot pressing a current collector-electrode composite obtained through the forming the first coating layer to the forming the second electrode layer;
removing the second coating layer from the first current collector together with a portion of the first electrode layer stacked on the second coating layer, a portion of the solid electrolyte layer stacked on the second coating layer, and a portion of the second electrode layer stacked on the second coating layer; and
stacking a second current collector on a surface of the second electrode layer of the current collector-electrode composite through the hot pressing and the removing the second coating layer.

2. The manufacturing method of an all-solid-state battery according to claim 1, wherein the first coating layer includes
a binder that is a thermoplastic resin with a melting point of 165° C. or more, and
a carbon material filler of 15% by volume or more as a volume % at 25° C. based on a total amount of the first coating layer, and
the second coating layer includes
a binder with a melting point of 110° C. or less, and/or a binder with a Young's modulus at 25° C. of 2.34 GPa or more and a relative dielectric constant at 25° C. of 3.45 or less, and
a carbon material filler of 20% by volume or more as a volume % at 25° C. based on a total amount of the second coating layer.

3. The manufacturing method of an all-solid-state battery according to claim 1, wherein
the first electrode layer is a negative electrode layer that includes a negative electrode active material, and
the second electrode layer is a positive electrode layer that includes a positive electrode active material.

4. A conductive coating current collector that has a conductive coating layer, the conductive coating current collector comprising:
a plate shaped, sheet shaped, or foil shaped conductive base material;
a conductive first coating layer provided in a first region that occupies one part of a first surface of the conductive base material; and
a second coating layer disposed adjacent to the first coating layer in a second region of the first surface of the conductive base material that occupies an outer peripheral side of the first coating layer, wherein the second coating layer is a coating layer more easily peeled off from the first surface of the conductive base material than the first coating layer.

5. The current collector according to claim 4, wherein
the first coating layer includes
a binder that is a thermoplastic resin with a melting point of 165° C. or more, and
a carbon material filler of 15% by volume or more as a volume % at 25° C. based on the total amount of the first coating layer, and
the second coating layer includes
a binder with a melting point of 110° C. or less, and/or a binder with a Young's modulus at 25° C. of 2.34 GPa or more and a relative dielectric constant at 25° C. of 3.45 or less, and
a carbon material filler of 20% by volume or more as a volume % at 25° C. based on a total amount of the second coating layer.

6. An all-solid-state battery comprising:
a first current collector;
a conductive coating layer provided in a first region that occupies one part of a first surface of the first current collector;
a first electrode layer that includes a first active material and has a first polarity, the first electrode layer being provided in contact with the coating layer without directly contacting the first current collector;
a solid electrolyte layer that includes a solid electrolyte;
a second electrode layer that includes a second active material and has a second polarity opposite to the first polarity;
a second current collector electrically connected to the second electrode layer; and
a stacked structure in which the first current collector, the conductive coating layer, the first electrode layer, the solid electrolyte layer, the second electrode layer, and the second current collector are stacked in order in a first direction, wherein
a second region not covered by the coating layer is present on an outer peripheral side of the first region of the first surface of the first current collector, and
an end surface of the coating layer, an end surface of the first electrode layer, an end surface of the solid electrolyte layer, and an end surface of the second electrode layer are aligned with one another.

7. The all-solid-state battery according to claim 6, wherein the coating layer includes
a binder that is a thermoplastic resin with a melting point of 165° C. or more, and
a carbon material filler of 15% by volume or more as a volume % at 25° C. based on the total amount of the first coating layer.
